(19) United States
(12) Patent Application Publication
(10) Pub. No.: US 2026/0191713 A1
(43) Pub. Date: Jul. 9, 2026

(54) PATIENT SUPPORT APPARATUS WITH BI-DIRECTIONAL OVERRUNNING CLUTCH AND TELESCOPING ADJUSTABLE HANDLES

(71) Applicant: Baxter Medical Systems GmbH + Co. KG, Saalfeld (DE)

(72) Inventor: Michael Buccieri, Greenfield, IN (US)

(73) Assignee: Baxter Medical Systems GmbH + Co. KG, Saalfeld (DE)

(21) Appl. No.: 19/434,493

(22) Filed: Dec. 29, 2025

Related U.S. Application Data
(60) Provisional application No. 63/741,648, filed on Jan. 3, 2025.

(51) Int. Cl. A61G 7/05

(52) U.S. Cl. CPC A61G 7/0528

(57) ABSTRACT

A patient support apparatus includes a frame, a plurality of casters operably coupled to the frame, and an omni wheel operably coupled to the frame about a primary axis and movable between lowered and raised positions. The omni wheel includes a plurality of rollers disposed about a periphery of the omni wheel. A drive assembly with first and second modes of operation is coupled to the omni wheel to drive the omni wheel and propel the frame in first and second directions, respectively. The omni wheel is free to rotate about the primary axis when the omni wheel is in the lowered position and the patient support apparatus is moved along a floor. The rollers disposed about the periphery of the omni wheel are configured to allow transverse movement of the omni wheel and the frame when the omni wheel is in the lowered position. First and second handles are operably coupled with the frame and rotatable between horizontal stowed and vertical deployed positions.

### CROSS-REFERENCE TO RELATED APPLICATION

This application claims priority to and the benefit under 35 U.S.C. § 119(e) of U.S. Provisional Application No. 63/741,648, filed on Jan. 3, 2025, entitled “PATIENT SUPPORT APPARATUS WITH BI-DIRECTIONAL OVERRUNNING CLUTCH AND TELESCOPING ADJUSTABLE HANDLES,” the disclosure of which is hereby incorporated herein by reference in its entirety.

### FIELD OF THE DISCLOSURE

The present disclosure generally relates to a patient support apparatus, and more particularly to a patient support apparatus that includes a powered fifth wheel with a bi-directional overrunning clutch, telescoping adjustable handles, and an omni wheel for lateral movement.

### SUMMARY OF THE DISCLOSURE

According to one aspect of the present disclosure, a patient support apparatus for transporting a patient includes a frame with a patient support surface and a plurality of casters that are operably coupled to the frame. An omni wheel is operably coupled to the frame about a primary axis and movable between a lowered position engaging a floor and a raised position spaced from the floor. The omni wheel includes a plurality of rollers disposed about a periphery of the omni wheel. The patient support apparatus also includes a drive assembly that has a first mode of operation coupled to the omni wheel to drive the omni wheel and propel the frame in a first direction and a second mode of operation decoupled from the omni wheel. The omni wheel is free to rotate about the primary axis when the omni wheel is in the lowered position and the patient support apparatus is moved along the floor. The plurality of rollers disposed about the periphery of the omni wheel are configured to allow transverse movement of the omni wheel and the frame when the omni wheel is in the lowered position. First and second handles are operably coupled with the frame and rotatable between a horizontal stowed position and a vertical deployed position.

According to another aspect of the present disclosure, a patient support apparatus for transporting a patient includes a frame that has a patient support surface and a plurality of casters that are operably coupled to the frame. An omni wheel is operably coupled to the frame and rotatable about a primary axis. The omni wheel includes a plurality of rollers disposed about a periphery of the omni wheel. The patient support apparatus also includes a drive assembly that has a first mode of operation coupled to the omni wheel to drive the omni wheel and propel the frame in a first direction and a second mode of operation decoupled from the omni wheel. The omni wheel is free to rotate about the primary axis when the omni wheel is in a lowered position and the patient support apparatus is moved along a floor. The plurality of rollers disposed about the periphery of the omni wheel are configured to allow transverse movement of the omni wheel and the frame when the omni wheel is in the lowered position.

According to another aspect of the present disclosure, patient support apparatus for transporting a patient includes a frame that has a patient support surface and a plurality of casters that are operably coupled to the frame. An omni wheel is operably coupled to the frame about a primary axis and movable. The omni wheel includes a plurality of rollers disposed about a periphery of the omni wheel and configured to allow transverse movement of the omni wheel and the frame when the omni wheel is in a lowered position. The patient support apparatus also includes drive assembly that includes a drive shaft, a transfer gear assembly that is operably coupled to the drive shaft, a bi-directional overrunning clutch, and an axle shaft. The drive assembly is configured to transfer torque from the drive shaft to the axle shaft by way of the bi-directional overrunning clutch. The drive assembly is configured to drive the omni wheel in a forward or rearward direction.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a top perspective view of a patient support apparatus of the present disclosure with first and second handles in a deployed position;

FIG. 2 is a side elevational view of a patient support apparatus of the present disclosure with first and second handles in a deployed position;

FIG. 3 is a top perspective view of a patient support apparatus of the present disclosure with first and second handles in a stowed position;

FIG. 4 is a side elevational view of a patient support apparatus of the present disclosure with first and second handles in a stowed position;

FIG. 5 is a top, front perspective view of a first handle in a deployed position of the present disclosure;

FIG. 6 is a top, rear perspective view a first handle in a deployed position of the present disclosure;

FIG. 7 is a side elevational view of a first handle in a deployed position of the present disclosure;

FIG. 8 is a top, rear perspective view of a first handle in a stowed position of the present disclosure;

FIG. 9 is a top, front perspective view of a first handle in a stowed position of the present disclosure;

FIG. 10 is a top, front perspective view of a second handle in a deployed position of the present disclosure;

FIG. 11 is a top, rear perspective view a second handle in a deployed position of the present disclosure;

FIG. 12 is a side elevational view of a second handle in a deployed position of the present disclosure;

FIG. 13 is a top, front perspective view of a second handle in a stowed position of the present disclosure;

FIG. 14 is a top, rear perspective view of a second handle in a stowed position of the present disclosure;

FIG. 15A is a first side perspective view of a drive assembly of the present disclosure;

FIG. 15B is a second side perspective view of a drive assembly of the present disclosure;

FIG. 16 is a cross-sectional view of a drive assembly of the present disclosure;

FIG. 17 is a first side elevational view of a drive assembly of the present disclosure;

FIG. 18 is a front elevational view of a drive assembly of the present disclosure;

FIG. 19 is a side elevational view of a drive assembly of the present disclosure;

FIG. 20 is a top plan view of a drive assembly of the present disclosure;

FIG. 21 is a side elevational view of a bi-directional overrunning clutch of the present disclosure;

FIG. 22A is schematic view of a bi-directional overrunning clutch of the present disclosure, shown in clockwise engagement;

FIG. 22B is schematic view of a bi-directional overrunning clutch of the present disclosure, shown in freewheeling or neutral engagement; and

FIG. 22C is schematic view of a bi-directional overrunning clutch in counterclockwise engagement.

### DETAILED DESCRIPTION

The present illustrated embodiments reside primarily in combinations of method steps and apparatus components related to a patient support apparatus that includes a powered fifth wheel with a bi-directional overrunning clutch, telescoping adjustable handles, and an omni wheel for lateral movement. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

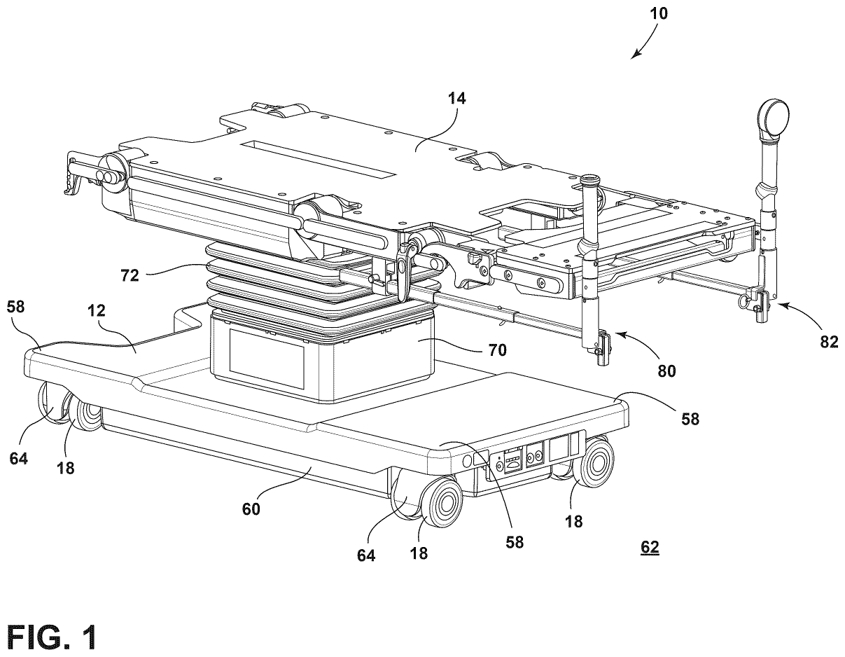

For purposes of description herein, the terms “upper,” “lower,” “right,” “left,” “rear,” “front,” “vertical,” “horizontal,” and derivatives thereof, shall relate to the disclosure as oriented in FIG. 1. Unless stated otherwise, the term “front” shall refer to a surface closest to an intended viewer, and the term “rear” shall refer to a surface furthest from the intended viewer. However, it is to be understood that the disclosure may assume various alternative orientations, except where expressly specified to the contrary. It is also to be understood that the specific structures and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

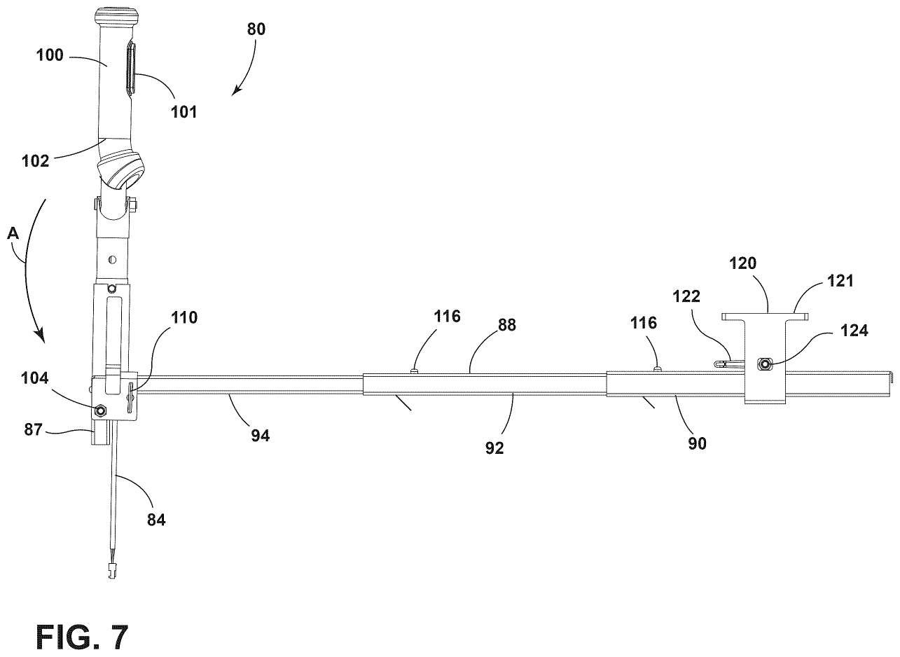

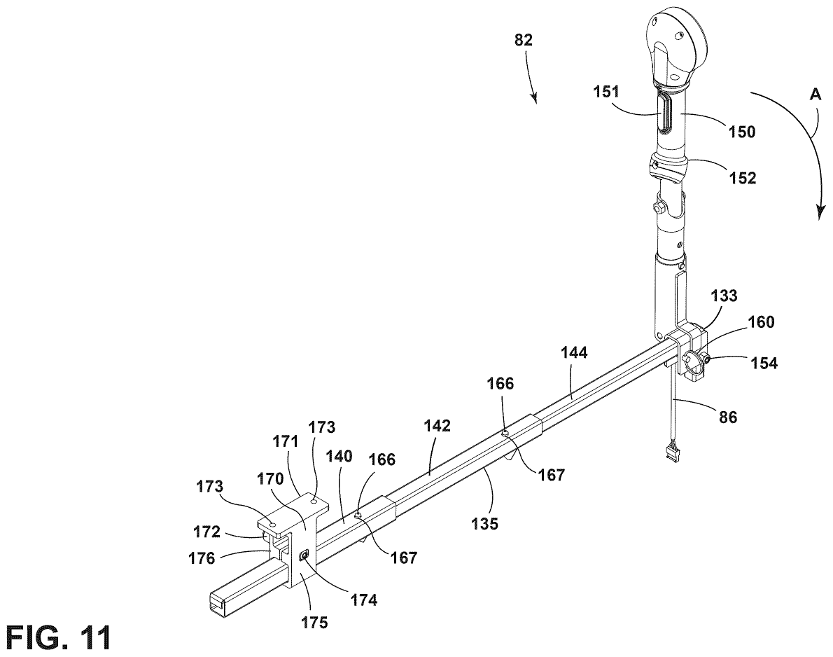

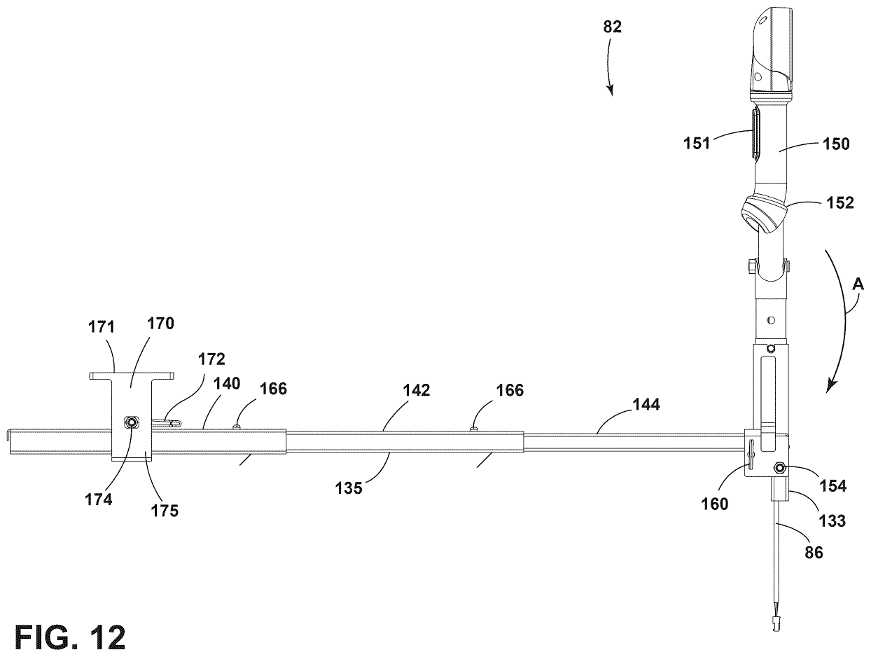

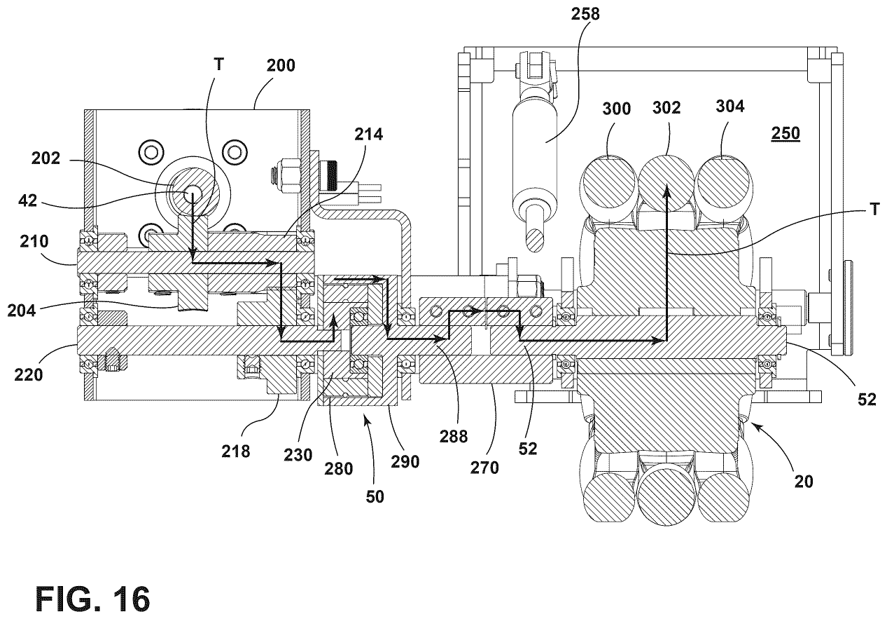

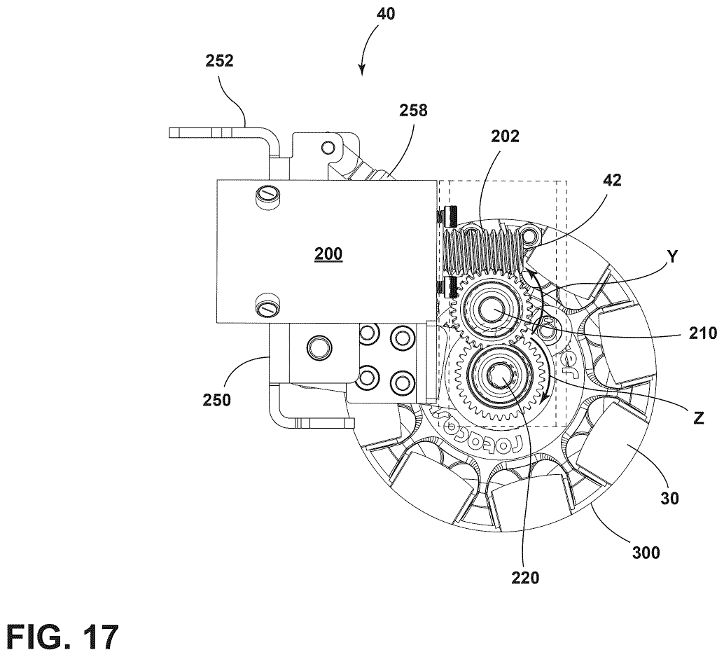

Referring to FIGS. 1-17, reference numeral 10 generally designates a patient support apparatus for transporting a patient. The patient support apparatus 10 includes a frame 12 having a patient support surface 14 and a plurality of casters 18 operably coupled to the frame 12. The patient support apparatus 10 also includes an omni wheel 20 operably coupled to the frame 12 about a primary axis PA and movable between a lowered position engaging a floor and a raised position spaced from the floor, the omni wheel 20 including a plurality of rollers 30 disposed about a periphery 32 of the omni wheel 20. The patient support apparatus 10 has a drive assembly 40 that includes a drive shaft 42 and a transfer gear assembly 44 operably coupled to the drive shaft 42. The patient support apparatus 10 also includes a bi-directional overrunning clutch 50 and an axle shaft 52, wherein the drive assembly 40 is configured to transfer torque from the drive shaft 42 to the axle shaft 52 by way of the bi-directional overrunning clutch 50, the drive assembly 40 being configured to drive the omni wheel 20 in a forward or rearward direction, and wherein the plurality of rollers 30 disposed about the periphery 32 of the omni wheel 20 are configured to allow transverse movement of the omni wheel 20 and the frame 12 when the omni wheel 20 is in the lowered position.

With reference again to FIGS. 1-4, the casters 18 are mounted to each corner 58 of a lower portion 60 of the frame 12 so that the patient support apparatus 10 can be rolled over a floor 62 across which a patient is being transported. It is contemplated that in some instances brake pedals 64 may be utilized that are pivotably coupled to the lower portion 60 proximate one or more of the casters 18 to lock the casters 18 in place. In addition, hydraulic posts disposed under or adjacent to the frame 12 are deployable to lift the frame upward. It is contemplated that the drive assembly 40 may disengage when the hydraulic posts are deployed, or lowered, thereby effectively placing the casters 18 in a braked condition. Alternatively, the patient support apparatus 10 may include a single brake pedal 64 coupled to the lower frame 60 to control the braking of all the casters 18. The drive assembly 40 is disabled from driving the omni wheel 20 when the casters 18 are braked. The lower portion 60 of the frame 12 supports a pedestal 70 that is configured to raise and lower the patient support surface 14. The pedestal 70 is covered by a flexible accordion-type cover 72 that flexibly covers an internal elevating mechanism from view. The cover 72 also protects the internal elevating mechanism from fluids, dirt, debris, etc. and possible damage during use.

The drive assembly 40 is disposed in the lower portion 60 of the frame 12 and may also be partially disposed in the pedestal 70. The casters 18 and omni wheel 20 are configured to allow for horizontal translation of the patient support apparatus 10. A host of other controls may also be provided on the patient support apparatus 10. The drive assembly 40 may have a first mode of operation coupled to the omni wheel 20 to drive the omni wheel 20 and propel the frame 12 in a first direction. The drive assembly 40 may also have a second mode of operation where the drive assembly 40 is deactivated or otherwise decoupled from the omni wheel 20.

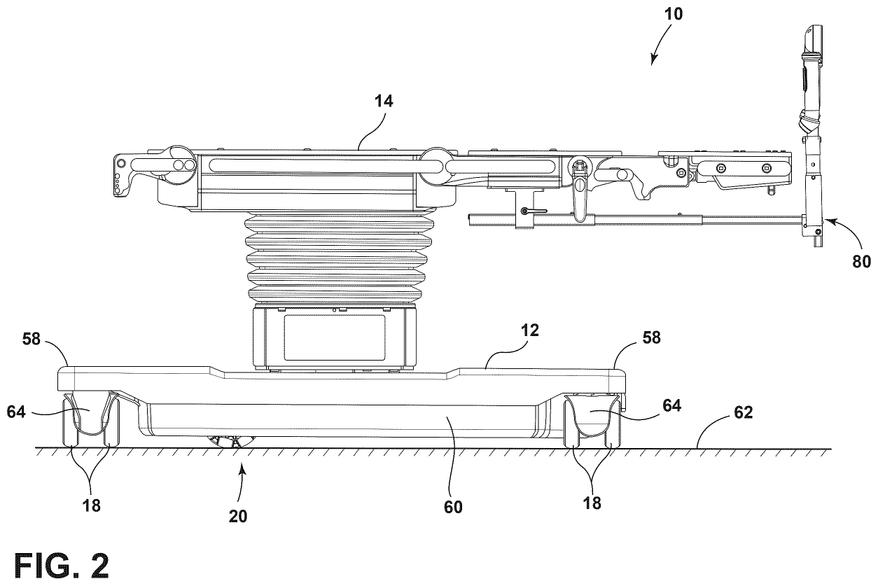

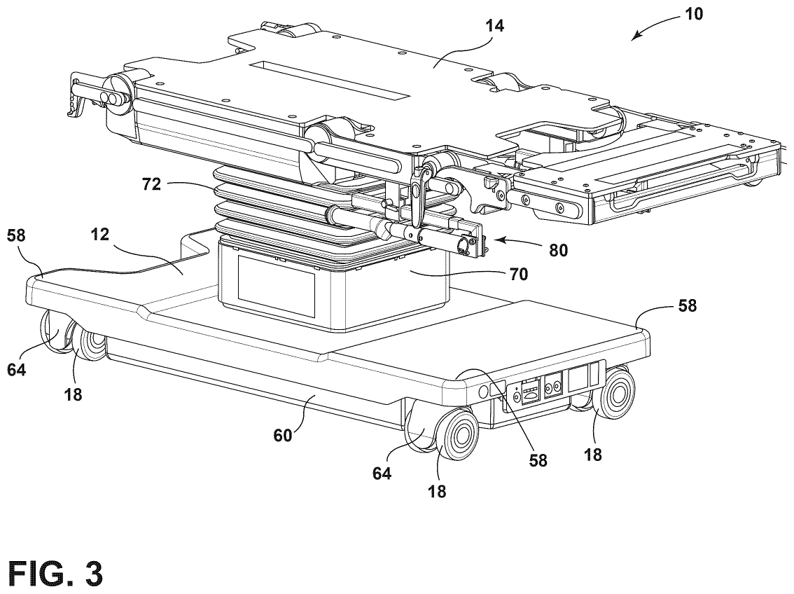

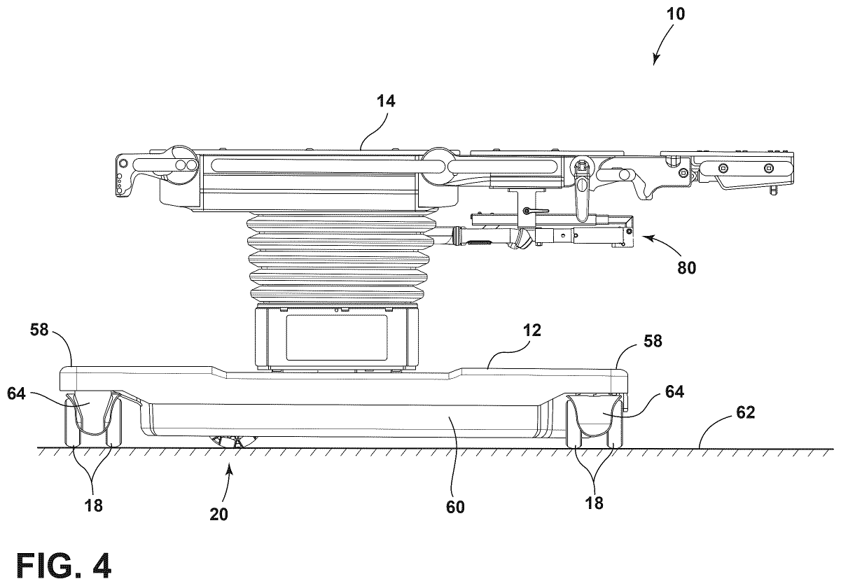

With reference once again to FIGS. 1-4, the patient support apparatus 10 includes first and second handles 80, 82 that are movable between a stowed position and an extended, or deployed, position. The first and second handles 80, 82 are shown in a deployed position in FIGS. 1 and 2 and in a stowed position in FIGS. 3 and 4. In the deployed position, all functionality is provided to the handles 80, 82. More specifically, the handles 80, 82 are in a powered condition where input from a user, or caregiver, can be directed through data lines 84, 86 to a controller of the patient support apparatus 10 to aid the user in moving and steering the patient support apparatus 10.

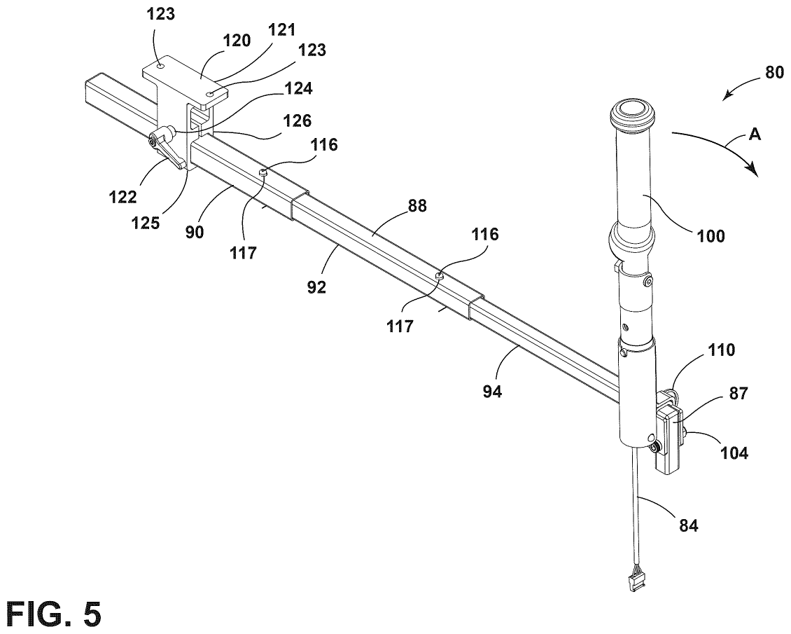

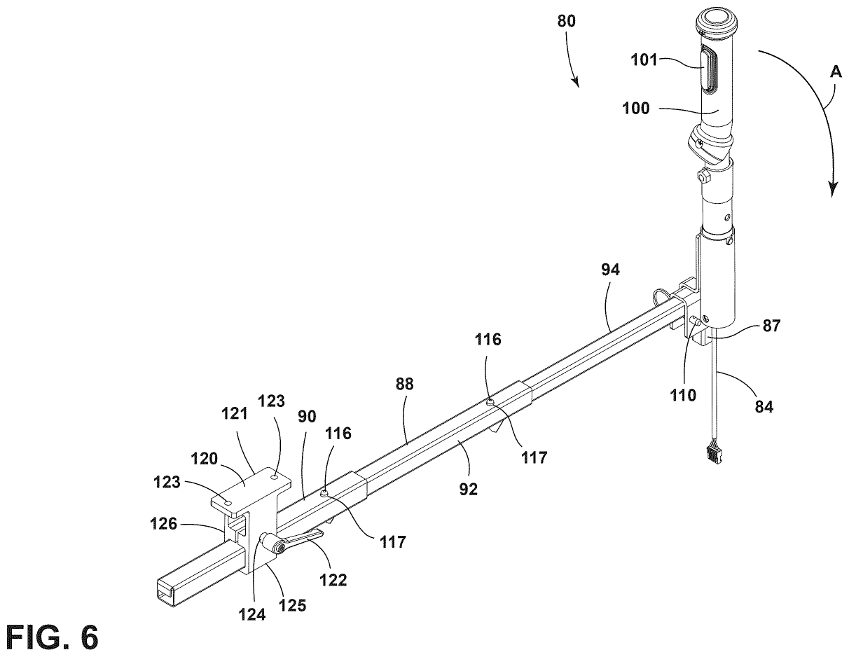

With reference to FIGS. 5 and 6, the first handle 80 is operably coupled to a distal end 87 of a first telescoping support 88. The first telescoping support 88 is illustrated with three slidably coupled sections 90, 92, 94 that allow for linear translation of the first handle 80 between the stowed position and the deployed position. The three sections include a proximal section 90, a medial section 92, and a distal section 94. As illustrated in FIGS. 5 and 6, the section 90 is configured to receive the section 92 therein. The section 90 is hollow and includes a width and height that is greater than a width and height of the section 92. In a similar fashion, the section 94 is configured to be inserted into the section 92. The section 92 includes a height and width that is greater than a height and width of the section 94. Although the sections 90, 92, 94 are slidably received in a telescoping manner, it is also contemplated that the sections 90, 92, 94 could be slidably associated without being telescopingly engaged.

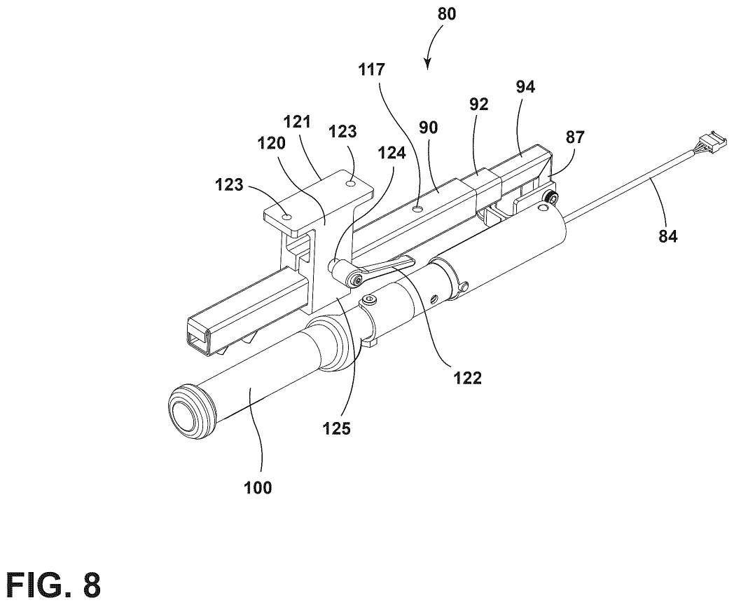

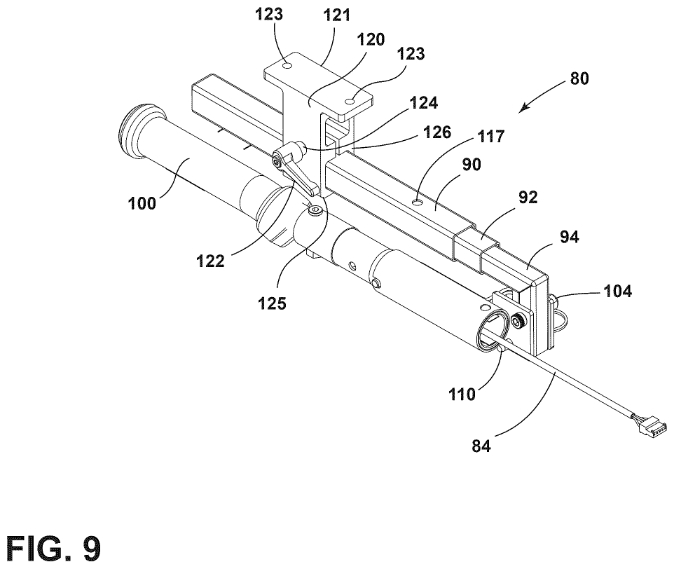

It is contemplated that the first handle 80 may be rotated relative to the first telescoping support 88 and, when the first handle 80 is in the stowed position, a linear extent of the first telescoping support 88 is parallel with a linear extent of the first handle 80. This functionality effectively moves the first handle 80 into the stowed position, which is out of the way of a caregiver who is providing care to a patient. The first handle 80 includes a grip 100 and a trigger switch 101 on a distal end 102 thereof that is configured for rotation about a pivot axis 104. The first handle 80 is maintained in the stowed position and the deployed position by a securing pin 110. However, a caregiver or user can remove the securing pin 110 that maintains the first handle 80 in a vertical position. When the pin 110 is removed, the first handle 80 is free to rotate about arrow A from the vertical position to a horizontal position. In addition, detents 116 can be pushed into apertures 117 of the slidably coupled sections 90, 92 so that the section 92 can be received within the section 90 and the section 94 can be received within the section 92. The detents 116 may be spring-loaded and configured to snap-fittingly engage the apertures 117. Also, the section 90 can be slid into a clamp 120 that secures the section 90 relative to the patient support apparatus 10. The clamp 120 includes an engagement member 121 that includes mechanical fastener apertures 123 for receiving mechanical fasteners that secure the first handle 80 to the patient support apparatus 10. The clamp 120 also includes a handle 122 that is operable between a clamped condition and a loosened condition. In the clamped condition, a drawbar 124 disposed between first and second arms 125, 126 of the clamp 120 draws the first and second arms 125, 126 together thereby clamping the section 90. It is contemplated that the section 90 may be moved anywhere within the clamp 120 along a linear extent of the section 90. When the first handle 80 is rotated to the horizontal position and the sections 90, 92, 94 are nested and the section 90 has been slid forward into the clamp 120, the first handle 80 is in the stowed position, as shown in FIGS. 8 and 9.

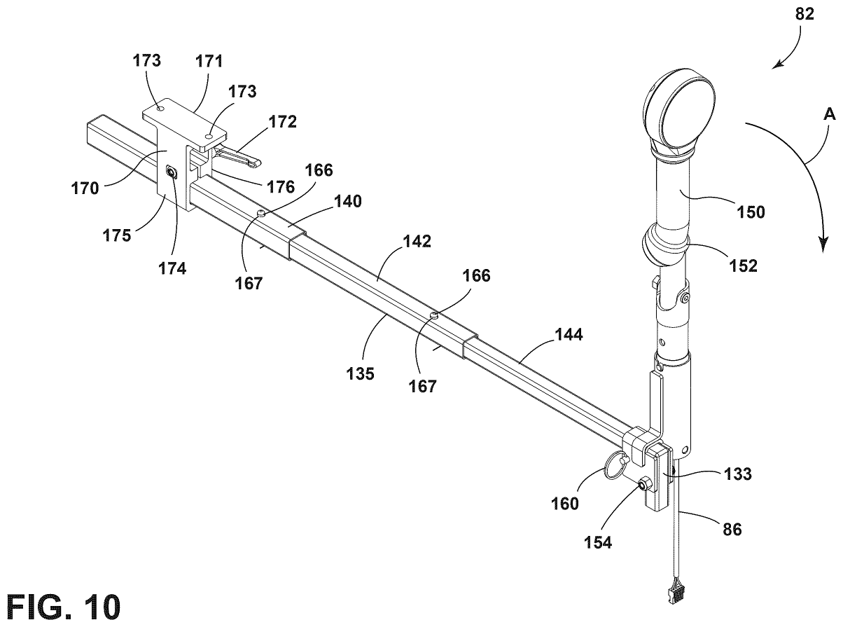

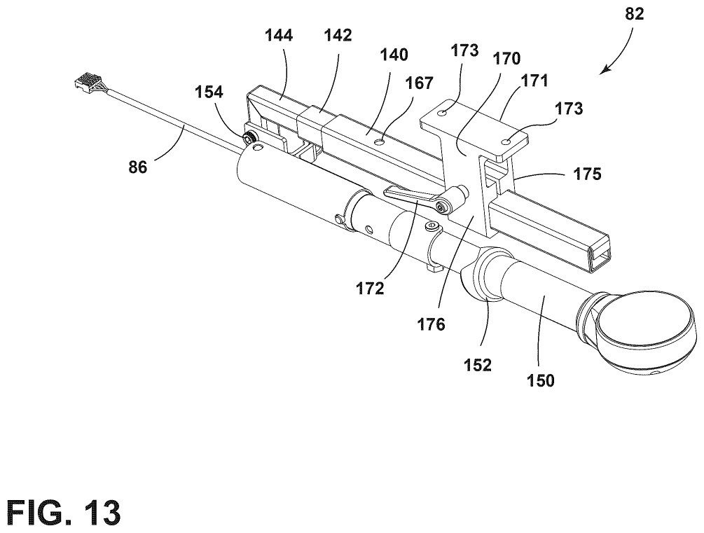

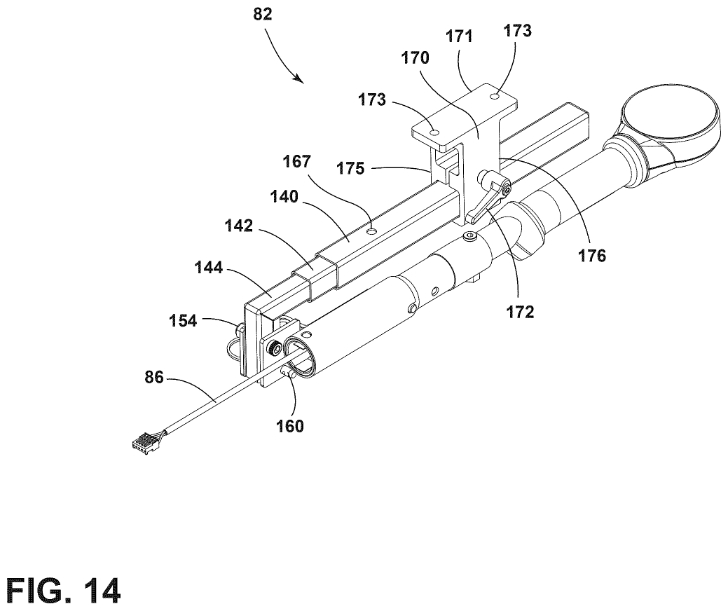

As shown in FIGS. 10-12, in a similar fashion, the second handle 82 is operably coupled to a distal end 133 of a first telescoping support 135. The first telescoping support 135 is illustrated with three slidably coupled sections 140, 142, 144 that allow for linear translation of the second handle 82 between the stowed position and the deployed position. Similar to the slidably coupled sections 90, 92, 94 of the first telescoping support 88, the slidably coupled sections 140, 142, 144 are also telescopingly engaged and include a proximal section 140, a medial section 142, and a distal section 144. However, the sections 140, 142, 144 could also be engaged in other slidable arrangements. It is contemplated that the second handle 82 may be rotated relative to the second telescoping support 135 and, when the second handle 82 is in the stowed position, a linear extent of the second telescoping support 135 is parallel with a linear extent of the second handle 82. This effectively moves the second handle 82 into the stowed position, which is out of the way of a caregiver who is providing care to a patient. The second handle 82 includes a grip 150 and a trigger switch 151 on a distal end 152 thereof that is configured for rotation about a pivot axis 154. The second handle 82 is maintained in the stowed position and the deployed position by a securing pin 160. However, a caregiver or user can remove the securing pin 160 that maintains second handle 82 in a vertical position. When the securing pin 160 is removed, the second handle 82 is free to rotate about arrow A from the vertical position to the horizontal position. In addition, detents 166 can be pushed into apertures 167 of the sections 140, 142 so that the section 142 can be received within the section 140 and the section 144 can be received within the section 142. The detents 166 may be spring-loaded and configured to snap-fittingly engage the apertures 167. Also, the section 140 can be slid into a clamp 170 that secures the section 140 relative to the patient support apparatus 10. The clamp 170 includes an engagement member 171 that includes mechanical fastener apertures 173 for receiving mechanical fasteners that secure the second handle 82 to the patient support apparatus 10. The clamp 170 includes a handle 172 that is operable between a clamped condition and a loosened condition. In the clamped condition, a drawbar 174 that is disposed between first and second arms 175, 176 of the clamp 170 draws the first and second arms 175, 176 together thereby clamping the section 90. It is contemplated that the section 90 may be moved anywhere within the clamp 170 along a linear extent of the section 140. When the second handle 82 is rotated to the horizontal position and the sections 140, 142, 144 are nested and the section 140 has been slid forward into the clamp 170, the second handle 82 is in the stowed position, as shown in FIGS. 13 and 14.

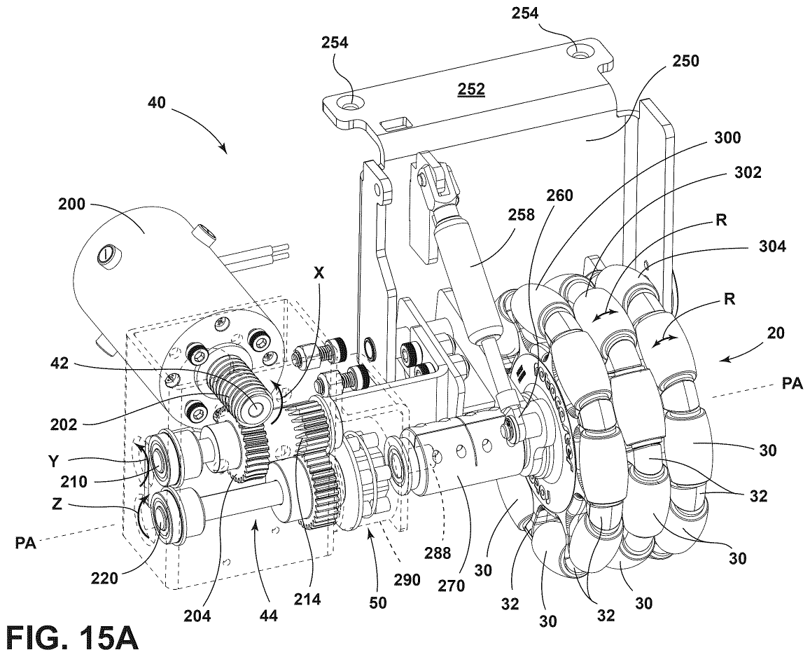

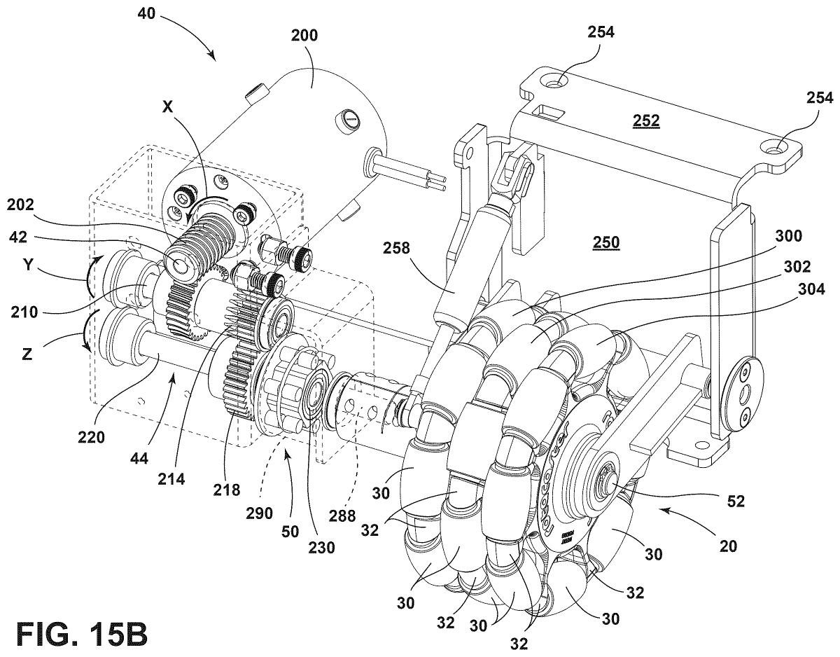

With reference now to FIGS. 15A-16, the drive assembly 40 is configured to move the omni wheel 20 in both a forward direction and a rearward direction by transferring force by way of torque from a motor 200 to the omni wheel 20. The torque is transferred along arrows T from the motor 200 to the omni wheel 20. The drive assembly 40 includes the motor 200 that supplies torque to, and consequently rotates, the drive shaft 42. The drive shaft 42 is threaded to form a worm gear 202 and configured to engage threads of a pinion gear 204 of a secondary orthogonal drive shaft 210. The secondary orthogonal drive shaft 210 also includes teeth on a distal end thereof that defines a power takeoff gear 214. The teeth of the power takeoff gear 214 are configured to engage teeth of a spur gear 218 that circumscribes a tertiary orthogonal drive shaft 220. The tertiary orthogonal drive shaft 220 is axially aligned with the bi-directional overrunning clutch 50 and the axle shaft 52 of the wheel 20. The tertiary orthogonal drive shaft 220 is configured to rotate and, consequently, to rotate an inner cam 230 of bi-directional overrunning clutch 50. Further explanation of the bi-directional overrunning clutch 50 is provided below. As the tertiary orthogonal drive shaft 220 continues to rotate the inner cam 230, the bi-directional overrunning clutch 50 engages and, consequently, applies torque to the omni wheel 20, as explained in further detail below. The application of torque to the omni wheel 20 causes rotation of the omni wheel 20 in a forward or rearward direction.

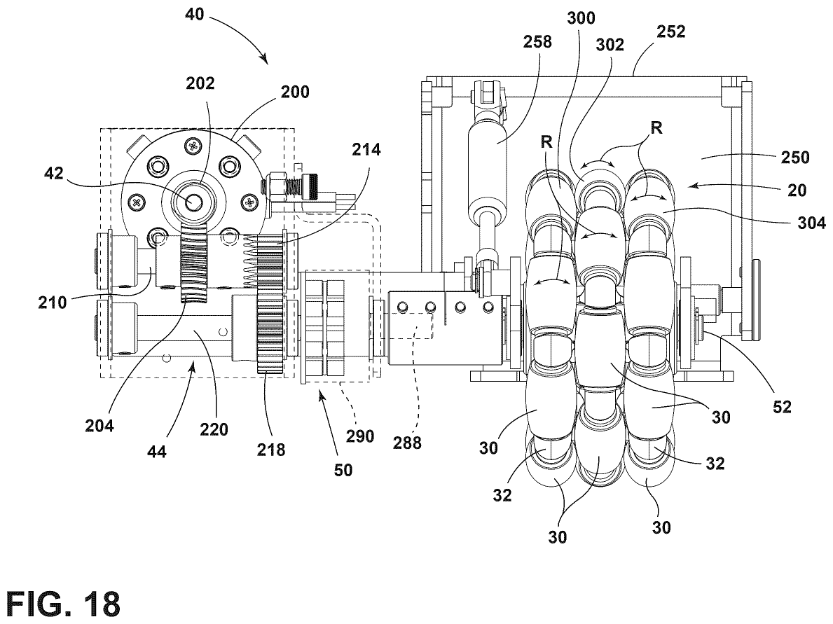

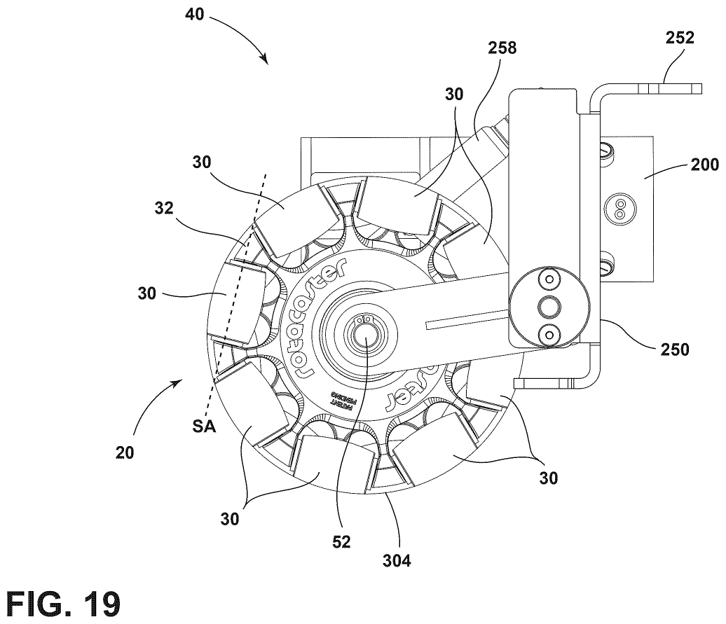

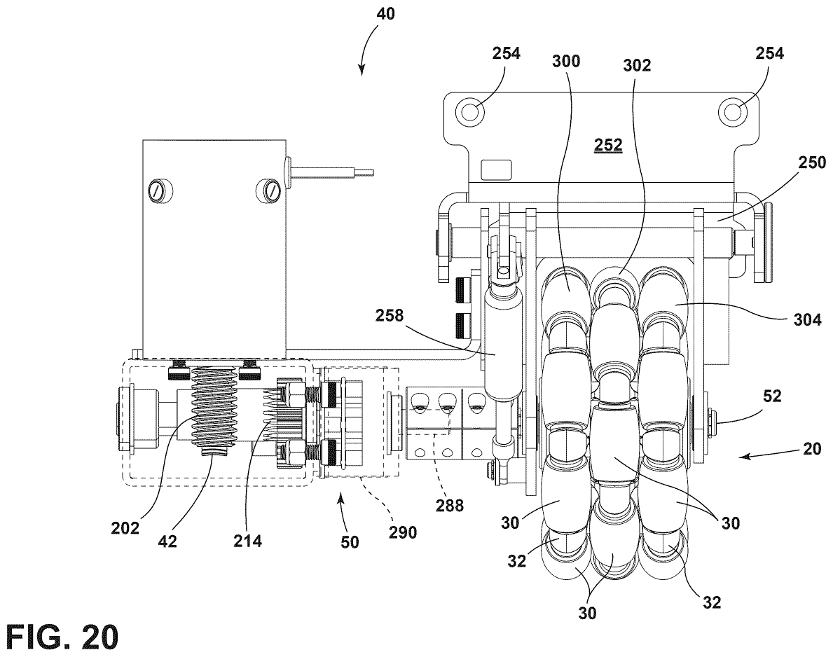

With reference again to FIGS. 13-20, the drive assembly 40 is operably coupled with the frame 12 by a lower frame member 250. The lower frame member 250 includes an upper transverse flange 252 that defines fastener apertures 254 configured to receive mechanical fasteners that secure the drive assembly 40 to the frame 12. The lower frame member 250 is rotatably coupled with a hydraulic lift or gas spring 258 that is also operably coupled with the omni wheel 20 at a lug 260. The hydraulic lift 258 is configured to adjust the vertical displacement of the omni wheel 20 relative to the floor. Accordingly, the hydraulic lift 258 can be used to place the omni wheel 20 in abutting contact with the floor or withdraw the omni wheel 20 from abutting contact with the floor. Thus, the omni wheel 20 is operable between a lowered position engaging the floor 62 and a raised position spaced from the floor 62. The hydraulic lift 258 may be configured to vertically adjust the omni wheel 20 to compensate for contours in the floor, thus allowing for a smoother and less jostling transport of a patient. Thus, the omni wheel 20 is operable between a lowered position engaging the floor 62 and a raised position spaced from the floor 62. It will be contemplated that a first user input may be configured to move the omni wheel between the raised and lowered positions. A second user input may be configured to signal the drive assembly to drive the omni wheel 20 when the drive assembly 40 is in the first mode of operation and the omni wheel 20 is in the lowered position.

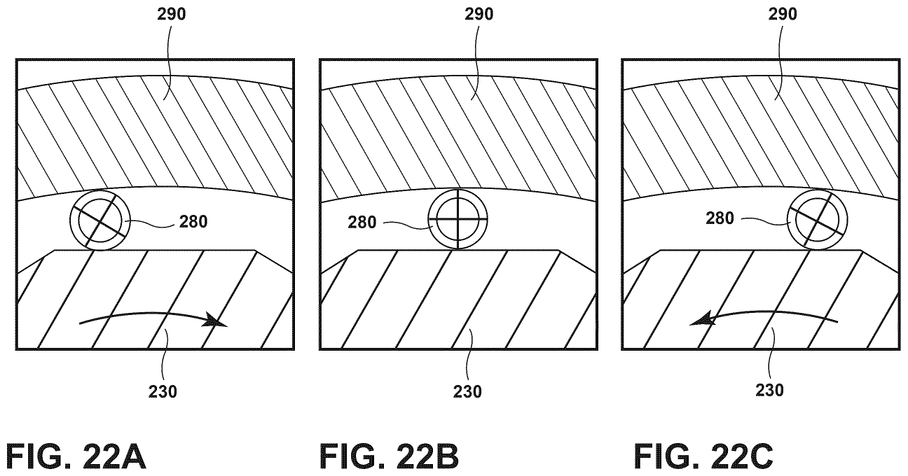

The omni wheel 20 is coupled with the axle shaft 52. Accordingly, when the axle shaft 52 rotates the omni wheel 20 also rotates. The axle shaft 52 extends from the omni wheel 20 toward the motor 200 and is encased in a shaft coupler 270 that clamps a race shaft 288 of an external race 290 of the bi-directional overrunning clutch 50 to the axle shaft 52 of the omni wheel 20. This connection rigidly couples the bi-directional overrunning clutch 50 output shaft to the axle shaft 52 of the omni wheel 20. The axle shaft 52 extends into the shaft coupler 270, which is also coupled to the external race 290 of the bi-directional overrunning clutch 50. When the tertiary orthogonal driveshaft 220 rotates in a clockwise direction, the inner cam 230 of the bi-directional overrunning clutch 50 also rotates clockwise. As the inner cam 230 rotates clockwise (FIG. 22A), internal rollers 280 move into abutting contact between the inner cam 230 and the external race 290. In this instance, the inner cam 230 and the external race 290 rotate together in a clockwise fashion, which consequently rotates the axle shaft 52 and the omni wheel 20 in a clockwise direction. In the event a caregiver chooses to move the patient support apparatus 10 in a reverse direction, the tertiary orthogonal driveshaft 220 rotates in a counterclockwise direction and, consequently so too does the inner cam 230. Initially, the inner cam 230 will move counterclockwise, which moves the internal rollers 280 to a free or neutral position. As the inner cam 230 continues to rotate counterclockwise, the internal rollers 280 are once again lodged between the external race 290 and the inner cam 230. Consequently, the external race 290 rotates counterclockwise with the inner cam 230. As the external race 290 and the inner cam 230 rotate, so too does the axle shaft 52 and the omni wheel 20.

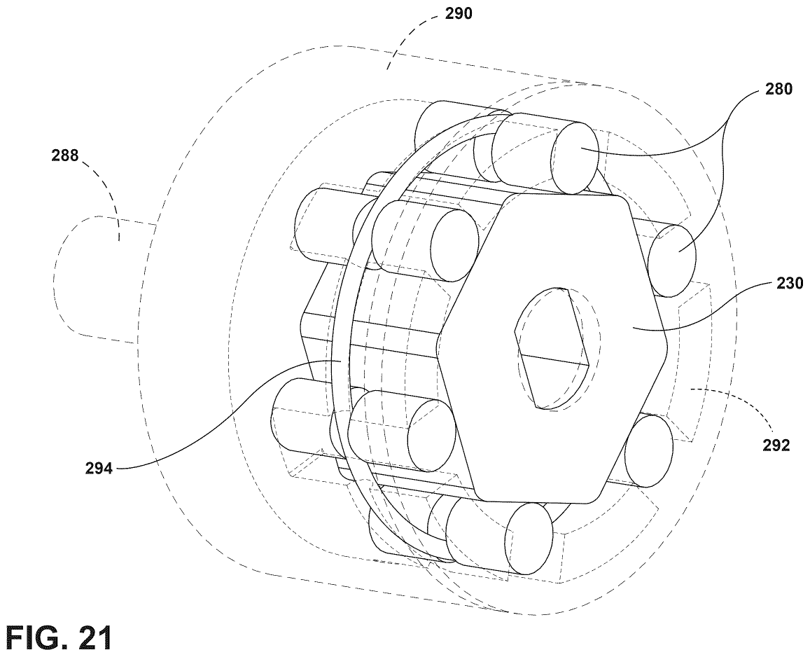

With reference to FIG. 21 and FIGS. 22A-22C, the bi-directional overrunning clutch 50 includes the inner cam 230, a plurality of the internal rollers 280, a roll cage 292 that separate each of the internal rollers 280, and the external race 290. The roll cage 292 maintains alignment and spacing of the internal rollers 280. An internal O-ring may extend about an inside surface of the external race 290 and retract the internal rollers 280 when the bi-directional overrunning clutch 50 is in a neutral condition. The external race 290 also includes the race shaft 288 that is fixedly coupled with the shaft coupler 270. The inner cam 230 directly receives torque supplied through the transfer gear assembly 44. Accordingly, when torque is ultimately received by the transfer gear assembly 44 from the motor 200 in the direction of arrow Z, that torque rotates the inner cam 230 which causes the internal rollers 280 to shift counter to the direction of rotation of the inner cam 230. When the internal rollers 280 are engaged with both the external race 290 and the inner cam 230, the external race 290 will rotate in the direction of the inner cam 230. When the external race 290 rotates in the direction of arrow Z, so too does the clutch shaft 296. Because the clutch shaft 296 is fixedly coupled to the shaft coupler 270, which is, in turn, fixedly coupled to the axle shaft 52, the torque from the motor 200 is then applied to the omni wheel 20.

Conversely, when torque is ultimately received by the transfer gear assembly 44, in a direction opposite of arrow Z, from the motor 200, that torque rotates the inner cam 230 which causes the internal rollers 280 to shift counter to the direction of rotation of the inner cam 230. When the internal rollers 280 are in abutting contact with both the external race 290 and the inner cam 230, the external race 290 will rotate in the direction of the inner cam 230. When the external race 290 rotates in the direction opposite of arrow Z, so too does the race shaft 288. Because the clutch shaft 296 is fixedly coupled to the shaft coupler 270, which is, in turn, fixedly coupled to the axle shaft 52, the torque from the motor 200 is then applied to the omni wheel 20.

With reference again to FIGS. 22A-22C, in the event a caregiver pushes the first and second handles 80, 82 and, consequently, the patient support apparatus 10 in a forward direction that is faster than the omni wheel spins based on the torque provided by the drive assembly 40, then the bi-directional overrunning clutch 50 will move to the free or neutral position such that the internal rollers 280 allow for movement of the external race 290 at a faster rate then the axle shaft 52 is rotating. This is also true, but in reverse, should a user move the patient support apparatus 10 rearwardly.

In operation, when a user applies a forward force on the first and second handles 80, 82, the motor 200 is activated and the drive shaft 42, along with the external worm gear 202, rotates in a counterclockwise direction following arrow X, with teeth of the external worm gear 202 drawing the engaged teeth of the pinion gear 204 rearward. As a result, the secondary orthogonal drive shaft 210 rotates counterclockwise in the direction of arrow Y. This causes the power take off gear 214 to rotate the spur gear 218 and, consequently, the tertiary orthogonal drive shaft 220 to rotate in the direction of arrow Z. As the tertiary orthogonal drive shaft 220 rotates clockwise in the direction of arrow Z, the internal rollers 280 of the bi-directional overrunning clutch 50 abut between the inner cam 230 and the external race 290. This action engages the axle shaft 52, and thereby rotates the omni wheel 20 in the direction of arrow Z. The omni wheel 20 is now translating the patient support apparatus 10 forward along the floor. The system operates in reverse when a user applies a rearward force to the first and second handles 80, 82. Specifically, when a user applies a rearward force on the first and second handles 80, 82, the motor 200 is activated and the drive shaft 42, along with the external worm gear 202, rotates in a clockwise direction opposite the direction of arrow X, with the teeth of the external worm gear 202 pushing the engaged teeth of the pinion gear 204 forward. As a result, the tertiary orthogonal drive shaft 220 rotates clockwise in a direction opposite of arrow Y. This causes the power takeoff gear 214 to rotate the spur gear 218 and, consequently, the tertiary orthogonal drive shaft 220 to rotate in a direction opposite of arrow Z. As the tertiary orthogonal drive shaft 220 rotates counterclockwise in the direction opposite of arrow Z, the internal rollers 280 of the bi-directional overrunning clutch 50 abut between the inner cam 230 and the external race 290. This action engages the axle shaft 52, and thereby rotates the omni wheel 20 in the direction opposite of arrow Z. The omni wheel 20 is now translating the patient support apparatus 10 rearward along the floor.

The patient support apparatus 10 of the present disclosure is configured to provide an integrated power assisted movement that can move the patient support apparatus 10 up to 1 mile/hour with up to a patient weight of 1000 lb or more with minimal user effort other than to initiate movement or change direction. A user can effect movement of the patient support apparatus 10 with one or both hands. The patient support apparatus 10 also includes intuitive steering control. The system operates at a very low decibel during activation as well as during startup and shutdown. The system is also configured to engage and disengage in less than 3 seconds and auto disengage after 5 seconds of non-use.

With reference again to FIGS. 13-20, the omni wheel 20, as illustrated, includes three rings. These rings include a first side ring 300, a central ring 302, and a second side ring 304. The first side ring 300, the central ring 302, and the second side ring 304 all include the same circumference and diameter and extend about the primary axis PA. The plurality of rollers 30 is disposed about the rings 300, 302, 304 and allow for lateral translation of the omni wheel 20 in a direction sideways to the direction of travel. As a result, the omni wheel 20 acts as a passive fifth wheel during steering. The rollers 30 of each of the rings 300, 302, 304 include bearings that allow for rotation of the rollers 30, as shown by arrows R. Each of the rollers 30 is configured to rotate about its own roller axis. Each roller axis is orthogonal (normal) to the primary axis PA. As illustrated, the plurality of rollers 30 are spaced intermittently about a circumference of each ring 300, 302, 304 and are also offset so that the rollers 30 on adjacent rings are not aligned. Although the illustrated construction shows eight rollers 30 on each ring 300, 302, 304, it will be understood that each ring 300, 302, 304 of the omni wheel 20 may include more or less rollers 30, depending on the application. Moreover, the omni wheel 20 may include more or less than three rings 300, 302, 304. The use of an omni wheel 20 such as that set forth herein and illustrated in FIGS. 13-20 provides additional versatility to the patient support apparatus 10 and allows for smoother transport of a patient over an uneven surface or floor.

The patient support apparatus 10 of the present disclosure includes a variable speed motor and gearbox, a bi-directional overrunning clutch, an omni wheel, ergonomically placed push handles, a handle mounting mechanism, and a control system with standalone batteries. The variable speed DC motor and gearbox provide the power assisted effort to move the patient support apparatus 10. The motor torque and speed combined with the gear ratio provides the appropriate amount of speed and torque to move the patient support apparatus 10 at up to the speed required based on output from the control system, which also takes into consideration varying weights of patients. The bi-directional overrunning clutch transfers torque from the gearbox to the omni wheel when the motor is commanded to drive by the control system. The clutch will only transfer torque to the omni wheel when the motor/gearbox is commanded to drive in the direction of travel at a speed equal to or greater than the speed the omni wheel is travelling. If the omni wheel is travelling at a speed faster than the motor/gearbox then no torque is transferred to the omni wheel (overrunning) from the motor. The same behavior occurs in both the forward and reverse directions. This allows the omni wheel to roll freely in forward or reverse when the motor and hence, the gearbox, is not turning. This construction also allows the patient support apparatus 10 to move forward or in reverse faster than the motor/gearbox is commanded by the user. The omni wheel is a special type of wheel that has rollers around the circumference that transmit torque in the rolling direction of the wheel but allow free, uncoupled transverse motion (sideways) because of the rollers spaced circumferentially around each ring of the wheel. The rollers rotate about an axis that is perpendicular to the primary axis of the omni wheel 20. Consequently, the wheel can be pushed sideways while in contact with the floor. The wheel used in this embodiment has three omni rings stacked together. Even though the omni wheel can roll sideways in a turn, the fact that the omni wheel is being driven forward in the turn, the omni wheel will have a tendency to pull the patient support apparatus 10 along the curved path. In contrast, if the patient support apparatus 10 is being pushed through a turn, the omni wheel will tend to allow the patient support apparatus 10 to also roll sideways potentially widening the turn radius. It should be noted that the omni wheel is mounted on a pivoting frame to accommodate variations in support surface-to-floor height of the patient support apparatus 10 and a gas spring provides a downward pressure to the floor. The patient support apparatus 10 can be raised on pistons disposed at corners of the patient support apparatus 10, which locks the patient support apparatus 10 from movement. When the patient support apparatus 10 is locked (raised on pistons), the omni wheel does not touch the floor.

The pressure applied by a hand or hands of a user to one or both of the first and second handles provides input to the control system to move in the direction of the hand pressure. The handles include a strain gage input device to control movement of the patient support apparatus 10. The enable trigger switch on either handle is used to enable movement of the patient support apparatus 10. A battery gage is provided on the second (right) handle. As noted above, the first and second handles fold from vertical to horizontal for storage when not in use. The supports for the handles include telescoping functionality that allows for multiple lengths of extension to accommodate different surgical table surface attachments. The telescoping mechanism is attached to the table with a sliding clamp that can accommodate additional length and infinite position adjustment. The handle mount is intended to be installed on either end of the patient support apparatus 10 to allow control from either end. The handles are spaced at an ergonomic width apart and a height of the patient support apparatus 10 can be adjusted vertically to provide an ergonomic handle height. The system is configured to detect when the patient support apparatus 10 is in the locked position (pistons down) or unlocked position (pistons up). A switch is attached to the pivoting frame of the omni wheel so that when the omni wheel is touching the floor, the system is enabled. As a result, the construction set forth herein is free of a stow and deploy actuator. However, it will be understood that two limit switches may be used to emulate the signals that would normally come from the actuator. These switches are also attached to the pivoting frame of the omni wheel and provide the feedback needed.

The motor and drive assembly can be sized to provide more or less torque and speed. The omni wheel can be changed to include more or less rings with rollers stacked together to provide an increased or decreased amount of traction. The gas spring can be any spring or counterweight to provide downforce for the omni wheel. In addition, the control system can be optimized to remove certain features from the design, such as a stow and deploy actuator circuit. The position of the omni wheel can be moved forward or rearward relative to the patient support surface 14 to change the traction or turning behavior of the patient support apparatus 10. Further, the manner and construction of the first and second telescoping supports can be changed to provide more or less adjustability or smoother operation, such as a continuously adjustable slide instead of discrete stops associated with locking detents. The handles could also be configured so that a single action to fold and retract the handles (depressing a button, rotating a lever, etc.).

It is also contemplated that a set of handles may be disposed at both ends of the patient support apparatus 10 so that the system can be operated from either end of the patient support apparatus 10 without spending time reconfiguring the current set up of the patient support apparatus 10. Because the bidirectional overrunning clutch does not require a ramp down to stop since it can overrun, and there is a slight mechanical delay to engage the clutch, the need for an engagement ramp or lag may be decreased or even eliminated. It is also contemplated that the gain of the first and second handles could be further adjusted to provide better response to user input. The batteries in this system are standalone and configured for recharging using conventional methods. The patient support apparatus 10 has substantial battery capacity. Several components in the control system are sized for the large current capacity of the motor/gearbox needed to drive the patient support apparatus 10. Because the patient support apparatus 10 set forth herein does not go up or down excessive ramps, the power needed to drive the motor is much less than in conventional hospital beds so higher capacity components which are often used may be downsized.

According to one aspect of the present disclosure, patient support apparatus for transporting a patient includes a frame with a patient support surface and a plurality of casters that are operably coupled to the frame. An omni wheel is operably coupled to the frame about a primary axis and movable between a lowered position engaging a floor and a raised position spaced from the floor. The omni wheel includes a plurality of rollers disposed about a periphery of the omni wheel. The patient support apparatus also includes a drive assembly that has a first mode of operation coupled to the omni wheel to drive the omni wheel and propel the frame in a first direction and a second mode of operation decoupled from the omni wheel. The omni wheel is free to rotate about the primary axis when the omni wheel is in the lowered position and the patient support apparatus is moved along the floor. The plurality of rollers disposed about the periphery of the omni wheel are configured to allow transverse movement of the omni wheel and the frame when the omni wheel is in the lowered position. First and second handles are operably coupled with the frame and rotatable between a horizontal stowed position and a vertical deployed position.

According to another aspect of the present disclosure, first and second handles are operably coupled with first and second telescoping supports, respectively.

According to another aspect of the present disclosure, a linear extent of a first telescoping support is parallel with a linear extent of a first handle and a linear extent of a second telescoping support is parallel with a linear extent of a second handle when the first and second handles are in a stowed position.

According to another aspect of the present disclosure, a patient support apparatus includes first and second telescoping supports and each of the first and second telescoping supports includes at least three slidably coupled sections.

According to another aspect of the present disclosure, a patient support apparatus includes first and second telescoping supports and each of the first and second telescoping supports includes at least three slidably coupled sections. The three sections include a proximal section, a medial section, and a distal section. The proximal section is selectively secured to a frame of the patient support apparatus by a hand adjustable clamp.

According to another aspect of the present disclosure, an omni wheel includes at least three rings.

According to another aspect of the present disclosure, rollers of adjacent rings are offset.

According to another aspect of the present disclosure, a drive assembly includes a drive shaft, a transfer gear assembly operably coupled to the drive shaft, and a bi-directional overrunning clutch.

According to another aspect of the present disclosure, a patient support apparatus includes an axle shaft that is operably coupled with an omni wheel. A drive assembly is configured to transfer torque from a drive shaft to the axle shaft by way of a bi-directional overrunning clutch.

According to another aspect of the present disclosure, an omni wheel acts as a passive fifth wheel during steering.

According to still another aspect of the present disclosure, a patient support apparatus for transporting a patient includes a frame that has a patient support surface and a plurality of casters operably coupled to the frame. An omni wheel is operably coupled to the frame about a primary axis and movable between a lowered position that engages a floor and a raised position that is spaced from the floor. The omni wheel includes a plurality of rollers disposed about a periphery of the omni wheel. The patient support apparatus also includes a drive assembly that has a first mode of operation coupled to the omni wheel to drive the omni wheel and propel the frame in a first direction and a second mode of operation decoupled from the omni wheel. The omni wheel is free to rotate about the primary axis when the omni wheel is in the lowered position and the patient support apparatus is moved along the floor. The plurality of rollers disposed about the periphery of the omni wheel are configured to allow transverse movement of the omni wheel and the frame when the omni wheel is in the lowered position.

According to another aspect of the present disclosure, a patient support apparatus includes a first user input configured to move an omni wheel between raised and lowered positions.

According to another aspect of the present disclosure, a patient support apparatus includes a second user input configured to signal a drive assembly to drive an omni wheel when the drive assembly is in a first mode of operation and the omni wheel is in a lowered position. The drive assembly is disabled from driving the omni wheel when casters are braked.

According to another aspect of the present disclosure, an omni wheel includes at least three rings encircling a primary axis.

According to another aspect of the present disclosure, each ring of the an omni wheel includes rollers that are spaced intermittently about a circumference of the ring.

According to another aspect of the present disclosure, each ring of the an omni wheel includes at least five rollers.

According to another aspect of the present disclosure, a patient support apparatus includes first and second handles that are operably coupled with a frame of the patient support apparatus. The first and second handles are operable between stowed and deployed positions.

According to another aspect of the present disclosure, a patient support apparatus includes first and second handles that are operably coupled with a frame of the patient support apparatus. Each of the first and second handles is operably coupled with a telescoping support.

According to another aspect of the present disclosure, a patient support apparatus includes a clamp that secures a telescoping support of each of first and second handles to a frame of the patient support apparatus.

According to another aspect of the present disclosure, each telescoping support includes at least three sections.

According to another aspect of the present disclosure, a patient support apparatus includes a spring-loaded detent disposed in at least one section. The spring-loaded detent is configured to snap-fittingly engage an aperture to secure one section of at least three sections of a telescoping support relative to an adjacent section of the telescoping support.

According to another aspect of the present disclosure, a patient support apparatus includes a clutch that allows a drive assembly to drive an omni wheel in a forward or rearward direction. The clutch allows the patient support apparatus to run ahead of input provided by the drive assembly.

According to yet another aspect of the present disclosure, a patient support apparatus for transporting a patient includes a frame that has a patient support surface and a plurality of casters operably coupled to the frame. An omni wheel is operably coupled to the frame about a primary axis and movable between a lowered position that engages a floor and a raised position that is spaced from the floor. The omni wheel includes a plurality of rollers disposed about a periphery of the omni wheel. The patient support apparatus also includes a drive assembly that includes a drive shaft, a transfer gear assembly that is operably coupled to the drive shaft, a bi-directional overrunning clutch, and an axle shaft. The drive assembly is configured to transfer torque from the drive shaft to the axle shaft by way of the bi-directional overrunning clutch. The drive assembly is configured to drive the omni wheel in a forward or rearward direction. The plurality of rollers disposed about the periphery of the omni wheel are configured to allow transverse movement of the omni wheel and the frame when the omni wheel is in the lowered position.

According to another aspect of the present disclosure, an omni wheel is configured to rotate about a primary axis. A plurality of rollers is disposed about a periphery of the omni wheel.

According to another aspect of the present disclosure, an omni wheel is operably coupled to a gas spring that is configured to vertically adjust the omni wheel to compensate for contours in a floor.

According to another aspect of the present disclosure, an omni wheel is disengaged by a drive assembly upon lowering of hydraulic posts proximate casters.

According to still another aspect of the present disclosure, a patient support apparatus for transporting a patient includes a frame that has a patient support surface and a plurality of casters operably coupled to the frame. An omni wheel is operably coupled to the frame and is configured to rotate about a primary axis. The omni wheel is movable between a lowered position that engages a floor and a raised position that is spaced from the floor. The omni wheel includes a plurality of rollers disposed about a periphery of the omni wheel. The patient support apparatus also includes a drive assembly that has a first mode of operation coupled to the omni wheel to drive the omni wheel and propel the frame in a first direction and a second mode of operation decoupled from the omni wheel. The omni wheel is free to rotate about the primary axis when the omni wheel is in the lowered position and the patient support apparatus is moved along the floor. The plurality of rollers disposed about the periphery of the omni wheel are configured to allow transverse movement of the omni wheel and the frame when the omni wheel is in the lowered position. A user input is configured to signal the drive assembly to drive the omni wheel when the drive assembly is in the first mode of operation and the omni wheel is in the lowered position. The drive assembly is disabled from driving the omni wheel when the plurality of casters are in a braked condition.

According to another aspect of the present disclosure, at least one roller rotates about an axis that is normal to a primary axis.

According to another aspect of the present disclosure, at least three rings are adjacent and include a first side ring, a central ring, and a second side ring. Each of the at least three rings includes rollers that are spaced intermittently about a circumference of each ring.

According to another aspect of the present disclosure, a patient support apparatus includes an axle shaft that is operably coupled with an omni wheel. A drive assembly is configured to transfer torque to the axle shaft.

According to another aspect of the present disclosure, a patient support apparatus includes a clutch disposed between a drive assembly and an omni wheel. The clutch is a free spinning overrunning clutch.

According to still another aspect of the present disclosure, a surgical table for supporting a patient during surgery includes a frame and a patient support surface that has a top surface configured to support the patient during the surgery. A lift column is configured to raise, lower, and tilt the patient support surface. An accessory attachment rail extends along at least one side of the patient support surface and lower than the top surface of the patient support surface. The accessory attachment rail is configured to receive accessories for use during the surgery. An omni wheel is operably coupled to the frame about a primary axis and is movable between a lowered position that engages a floor and a raised position that is spaced from the floor. The omni wheel includes a plurality of rollers disposed about a periphery of the omni wheel. The surgical table also includes a drive assembly that has a first mode of operation coupled to the omni wheel to drive the omni wheel and propel the frame in a first direction and a second mode of operation decoupled from the omni wheel. The omni wheel is free to rotate about the primary axis when the omni wheel is in the lowered position and the surgical table is moved along the floor. The plurality of rollers disposed about the periphery of the omni wheel is configured to allow transverse movement of the omni wheel and the frame when the omni wheel is in the lowered position.

According to another aspect of the present disclosure, adjacent rings include offset rollers.

According to another aspect of the present disclosure, a surgical table includes a bi-directional overrunning clutch.

According to yet another aspect of the present disclosure, a surgical table for supporting a patient during surgery includes a frame and a patient support surface supported by the frame that has a top surface configured to support the patient during the surgery. A lift column is configured to raise, lower, and tilt the patient support surface. An accessory attachment rail extends along at least one side of the patient support surface and lower than the top surface of the patient support surface. The accessory attachment rail is configured to receive accessories for use during the surgery. First and second handles are operably coupled with the frame and are rotatable between a horizontal stowed position, where the handles are beneath the accessory attachment rail, and a vertical deployed position, where a portion of the handles extend above the accessory attachment rail and above the patient support surface.

According to another aspect of the present disclosure, a removable pin secures each of a first handle and a second handle in a vertical deployed position.

According to another aspect of the present disclosure, a surgical table includes a clamp that secures first and second telescoping supports of first and second handles to a frame, respectively.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A patient support apparatus for transporting a patient, the patient support apparatus comprising:
a frame having a patient support surface;
a plurality of casters operably coupled to the frame;
an omni wheel operably coupled to the frame about a primary axis and movable between a lowered position engaging a floor and a raised position spaced from the floor, the omni wheel including a plurality of rollers disposed about a periphery of the omni wheel;
a drive assembly, the drive assembly having a first mode of operation coupled to the omni wheel to drive the omni wheel and propel the frame in a first direction, the drive assembly having a second mode of operation decoupled from the omni wheel, wherein the omni wheel is free to rotate about the primary axis when the omni wheel is in the lowered position and said patient support apparatus is moved along the floor, and wherein the plurality of rollers disposed about the periphery of the omni wheel are configured to allow transverse movement of the omni wheel and the frame when the omni wheel is in the lowered position;
first and second handles operably coupled with the frame and rotatable between a horizontal stowed position and a vertical deployed position.

2. The patient support apparatus of claim 1, wherein the first and second handles are operably coupled with first and second telescoping supports, respectively.

3. The patient support apparatus of claim 2, wherein a linear extent of the first telescoping support is parallel with a linear extent of the first handle and wherein a linear extent of the second telescoping support is parallel with a linear extent of the second handle when the first and second handles are in the stowed position.

4. The patient support apparatus of claim 2, wherein each of the first and second telescoping supports includes at least three slidably coupled sections.

5. The patient support apparatus of claim 4, wherein the three slidably coupled sections include a proximal section, a medial section, and a distal section and wherein the proximal section is selectively secured to the frame by a hand adjustable clamp.

6. The patient support apparatus of claim 4, wherein the omni wheel includes at least three rings.

7. The patient support apparatus of claim 6, wherein rollers of adjacent rings are offset.

8. The patient support apparatus of claim 1, wherein the drive assembly includes a drive shaft, a transfer gear assembly operably coupled to the drive shaft, and a bi-directional overrunning clutch.

9. The patient support apparatus of claim 8, further comprising:
an axle shaft operably coupled with the omni wheel, wherein the drive assembly is configured to transfer torque from the drive shaft to the axle shaft by way of the bi-directional overrunning clutch.

10. The patient support apparatus of claim 1, wherein the omni wheel acts as a passive fifth wheel during steering.

11. A patient support apparatus for transporting a patient, the patient support apparatus comprising:
a frame having a patient support surface;
a plurality of casters operably coupled to the frame;
an omni wheel operably coupled to the frame and rotatable about a primary axis, wherein the omni wheel includes a plurality of rollers disposed about a periphery of the omni wheel;
a drive assembly, the drive assembly having a first mode of operation coupled to the omni wheel to drive the omni wheel and propel the frame in a first direction, the drive assembly having a second mode of operation decoupled from the omni wheel, wherein the omni wheel is free to rotate about the primary axis when the omni wheel is in a lowered position and said patient support apparatus is moved along a floor, and wherein the plurality of rollers disposed about the periphery of the omni wheel are configured to allow transverse movement of the omni wheel and the frame when the omni wheel is in the lowered position.

12. The patient support apparatus of claim 11, further comprising:
a first user input configured to move the omni wheel between a raised position and the lowered position.

13. The patient support apparatus of claim 12, further comprising:
a second user input configured to signal the drive assembly to drive the omni wheel when the drive assembly is in the first mode of operation and the omni wheel is in the lowered position, wherein the drive assembly is disabled from driving the omni wheel when the casters are braked.

14. The patient support apparatus of claim 11, wherein the omni wheel includes at least three rings encircling the primary axis.

15. The patient support apparatus of claim 14, wherein each ring of the at least three rings includes rollers spaced intermittently about a circumference of each ring.

16. The patient support apparatus of claim 11, further comprising:
first and second handles operably coupled with the frame, wherein the first and second handles are operable between stowed and deployed positions.

17. A patient support apparatus for transporting a patient, the patient support apparatus comprising:
a frame having a patient support surface;
a plurality of casters operably coupled to the frame;
an omni wheel operably coupled to the frame about a primary axis and movable, the omni wheel including a plurality of rollers disposed about a periphery of the omni wheel and configured to allow transverse movement of the omni wheel and the frame when the omni wheel is in a lowered position; and
a drive assembly including:
a drive shaft;
a transfer gear assembly operably coupled to the drive shaft;
a bi-directional overrunning clutch; and
an axle shaft, wherein the drive assembly is configured to transfer torque from the drive shaft to the axle shaft by way of the bi-directional overrunning clutch, the drive assembly being configured to drive the omni wheel in a forward or rearward direction.

18. The patient support apparatus of claim 17, wherein the omni wheel acts as a passive fifth wheel during steering.

19. The patient support apparatus of claim 17, wherein the omni wheel is operably coupled to a gas spring configured to vertically adjust the omni wheel to compensate for contours in a floor.

20. The patient support apparatus of claim 17, wherein the omni wheel is disengaged by the drive assembly upon lowering of hydraulic posts proximate the casters.
